(19) United States
(12) Patent Application Publication
(10) Pub. No.: US 2010/0061009 A1
(43) Pub. Date: Mar. 11, 2010

(54) MAGNETIC DISK DEVICE

(75) Inventor: Keiji Watanabe, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/505,771

(22) Filed: Jul. 20, 2009

(30) Foreign Application Priority Data
Sep. 9, 2008 (JP) 2008-231232

(51) Int. Cl. G11B 21/02; G11B 5/127; G11B 5/187

(52) U.S. Cl. 360/75; 360/110; 360/122; G9B/21.003; G9B/5.04

(57) ABSTRACT

A magnetic disk device includes a magnetic storage medium including a surface coated with a first coating layer material having an elementary composition, and a magnetic head including a surface coated with a second coating layer material having the elementary composition.

### CROSS-REFERENCE TO RELATED APPLICATION

This application is based upon and claims the benefit of priority of the prior Japanese Patent Application No. 2008-231232, filed on Sep. 9, 2008, the entire contents of which are incorporated herein by reference.

### FIELD

The embodiments discussed herein are directed to a magnetic disk device.

### BACKGROUND

With the recent increase in the recording densities of storage media in magnetic disk devices, the magnetic spacing, i.e., the gap between a magnetic head and a magnetic storage medium, has become narrower and narrower. A flying height control technique of correcting the variation in the flying height of magnetic heads to keep such narrow gap spacing constant, called dynamic flying height (DFH), has been employed in magnetic disk devices.

With the use of the DFH in the magnetic disk devices, decrease in the minimum distance of the magnetic spacing in the read/write process to about 5 nanometers (nm) has been achieved.

Because the magnetic head is floating above a gap of nanometer-scale over the surface of the storage medium, the magnetic head needs to have smoothness at the atomic level. If fine impurities such as a little dust or dirt or the like adhere to the magnetic head, or if there is a little loss in the properties of the magnetic head, the magnetic head can lose its floating stability significantly.

Accordingly, techniques are disclosed for stably floating magnetic heads. For example, Japanese Laid-open Patent Publication No. 2006-12377 discloses a technique of subjecting the surface of a magnetic head to a fluorine compound treatment to prevent impurities in the air from adhering to the surface. Moreover, Japanese Laid-open Patent Publication No. 2006-318607 discloses a technique of subjecting a storage medium to a surface treatment so that the storage medium has improved durability and the magnetic head is able to float stably. Furthermore, Japanese Laid-open Patent Publication No. 2001-344708 discloses a technique for preventing a magnetic head from corroding.

However, in the above conventional techniques, an electric charge generated as a magnetic head contacts with a storage medium transfers between the magnetic head and the storage medium, which causes an adverse effect on the magnetic head or the storage medium.

For example, as an electric charge transfers between a magnetic head and a storage medium, a difference in the electric charges between the magnetic head and the storage medium is generated, exerting an electrostatic force. The electrostatic force is larger than the van der Waals' force acting in the magnetic spacing. Thus the magnetic head becomes electrostatically attracted towards the storage medium, disturbing the floating characteristics of the magnetic head.

Moreover, since the size of magnetic resistance (MR) elements in magnetic heads has become smaller and the sensitivity of these elements has increased, the elements are more easily affected by electric charges. Therefore, when an electric charge transfer occurs between a magnetic head and a magnetic storage medium, an electric current due to the electric charge transfer exceeds a predetermined threshold, the electric current is momentarily discharged to an MR element, and thus the characteristics of the magnetic head are degraded.

In particular, because tunneling magnetic resistance (TuMR) elements having a high resistance effect are used recently and insulating layers are formed in the TuMR elements, the above influence is more emphasized.

### SUMMARY

According to an aspect of the present invention, a magnetic disk device includes a magnetic storage medium including a surface coated with a first coating layer material having an elementary composition, and a magnetic head including a surface coated with a second coating layer material having the elementary composition.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram of an example of a magnetic disk device according to a first embodiment of the present invention;

FIG. 2 is a cross-sectional view indicating a relationship between a magnetic head and a magnetic storage medium of the magnetic disk device depicted in FIG. 1;

FIG. 3 is a schematic diagram for explaining a film forming process according to the first embodiment of the present invention; and

FIG. 4A and FIG. 4B are schematic diagrams for explaining an advantage of the magnetic disk device depicted in FIG. 1.

### DESCRIPTION OF EMBODIMENTS

Exemplary embodiments of a magnetic disk device according to the present invention are described in detail below with reference to the accompanying drawings.

### [A] First Embodiment

An outline and characteristics of a magnetic disk device according to a first embodiment are explained. In the magnetic disk device, materials of coating layers coating surfaces of a magnetic storage medium and a magnetic head have a same elementary composition. The minimum distance of a magnetic spacing during a read/write process is approximately greater than 0 nm and less than 3 nm.

The surfaces of the magnetic storage medium and the magnetic head are coated with the same coating layer material, so that there is no difference in electro-negativities of molecules composing the material of the coating layers of the magnetic storage medium and the magnetic head. As a result, electron transfer due to a difference in their electron-accepting properties and electron-donative properties and thus charge transfer are suppressed.

Moreover, since the minimum distance of the magnetic spacing is approximately greater than 0 nm and less than 3 nm, the van der Waals' force between the molecules composing the materials of the coating layers of the magnetic head and the magnetic storage medium acts effectively to maintain the floating stability of the magnetic head.

A total of film thicknesses of the materials of the coating layers (thickness of the material of the coating layers) coating the surfaces of the magnetic storage medium and the magnetic head is 2 nm or less, and the film thickness on the magnetic head is equal to or less than the film thickness on the magnetic storage medium.

If the total of the film thicknesses of the coating layers is large, the material of the coating layer on the magnetic storage medium may adhere to the magnetic head excessively, degrading the floating characteristics of the magnetic head. Therefore, the magnetic head is preferably coated with a smaller film thickness.

Thus, in the present embodiment, to reduce the film thickness, molecules of the materials of the coating layers cover the surfaces without overlapping each other in a floating height direction. Consequently, the film thickness per molecular layer (e.g. corresponding to a diameter of a molecule) becomes 1 nm or less, and the total of the film thicknesses of the materials of the coating layers on the surfaces of the magnetic storage medium and the magnetic head becomes 2 nm or less.

A fluorine compound is used as an example of the material of the coating layer coating the surface of the magnetic storage medium. The fluorine compound lowers a surface free energy of the magnetic storage medium, coats a wide area thinly, and suppresses adhesion of impurities.

The surface free energy is an energy that attracts substances. Therefore, if the surface free energy is low, impurities or the like are not attracted to the surface. For example, as is apparent from a fluorine-coated frying pan repelling water or oil, the fluorine compound lowers the surface activity and does not attract contaminants, dust, dirt, or the like in the air.

Examples of the fluorine compound include a perfluoropolyether generally known as a lubricant. If the perfluoropolyether includes a polar molecular end group such as a hydroxy group, impurities are attracted. Therefore, in the present embodiment, the perfluoropolyether does not include a polar molecular end group such as a hydroxy group.

The perfluoropolyether includes at least one of of a —CF₃ (fluorocarbon) molecular end group and a —CH₃ (hydrocarbon) molecular end group, and does not include a monomeric unit including —CF₂O—, to suppress decomposition of a molecular main chain of the perfluoropolyether.

The surface free energy of the magnetic storage medium is preferably lowered as much as possible. If the materials of the coating layers are composed of a fluorine compound consisting entirely of C—F bonds, the materials of the coating layers cannot be effectively adsorbed on a diamond like carbon (DLC) that forms protective films over the magnetic storage medium and the magnetic head. Therefore, conventionally, for example, a material of a coating layer is adsorbed on a DLC by mixing oxygen in the material of the coating layer to utilize the polarity of the oxygen atom.

However, such adsorption utilizing the polarity of the oxygen atom is not strong enough to maintain the floating characteristics of the magnetic head, and provides a low bonding rate. The bonding rate in the present embodiment indicates adsorbability of the material of the coating layer to the DLC. If the bonding rate is high, the adsorbability of the material of the coating layer to the DLC is large.

If the bonding rate is low, the material of the coating layer on the magnetic storage medium evaporates, so that electric charge accumulation or electric charge transfer tends to occur easily in the magnetic storage medium or the magnetic head due to transfer of the material of the coating layer to the magnetic head or drop of the transferred material.

The magnetic disk device according to the present embodiment includes a dynamic flying height (DFH) mechanism that corrects variation in the flying height of the magnetic head before the magnetic head is shipped.

Specifically, a head element of the magnetic head is expanded by turning on a heater in the magnetic head. As the expanded head element is brought into contact with the magnetic storage medium, vibration is generated, and consequently, a read waveform of the magnetic disk device is distorted, enabling detection of the contact.

After detecting the contact vibration, the heater is turned off, so that the expanded portion of the head element returns to its original state, thereby the expanded portion becoming the magnetic spacing. As a result, the variation in the flying height of the magnetic head is adjusted.

Accordingly, if any impurities are adhered to the surfaces of the magnetic storage medium and/or the magnetic head, it is difficult to detect the contact vibration. Therefore, impurities or the like are preferably prevented from being adsorbed on the materials of the coating layers.

As explained above, in order to lower the surface free energy as much as possible, to increase the bonding rate, and to make the detection of the contact vibration by the DFH mechanism easy, the magnetic head and the magnetic storage medium are preferably manufactured under conditions suppressing oxidation that is unnecessary for adsorption on the DLC and adsorption of impurities on the materials of the coating layers.

Thus, a manufacturing apparatus (not depicted) irradiates the magnetic head and the magnetic storage medium with a radiation under an inert gas atmosphere that realizes a low oxygen environment or under vacuum to manufacture the magnetic head and the magnetic storage medium. The radiation may be for example at least one of an ultraviolet ray, a far-ultraviolet ray, a vacuum-ultraviolet ray, an extreme-ultraviolet ray, an X-ray, and an electron ray.

When the magnetic head or the magnetic storage medium is irradiated with the radiation, excited photoelectrons are emitted from molecules composing the material of the coating layer and DLC, and both of the molecules become free radicals.

When the molecules in the free radical state return to the original stable state, the molecules form covalent bonding. Consequently, the materials of the coating layers are adsorbed on the DLC by the covalent bonding with a high bonding rate.

Thus, the magnetic head and the magnetic storage medium are preferably irradiated with a radiation of a wavelength that enhances emission of as many photoelectrons as possible from the materials of the coating layers and DLC. Therefore, the magnetic head and the magnetic storage medium are irradiated with emission lines of a wavelength of 185 nm or 172 nm, which allow emission of more photoelectrons, to adsorb the materials of the coating layers on the DLC.

In the present embodiment, a xenon (Xe) excimer lamp is used to irradiate the entire surfaces of the magnetic head and the magnetic storage medium. The Xe excimer lamp radiates many emission lines of a wavelength of 172 nm, which effectively cause the molecules of the coating layers and DLC to be in the free radical state, and radiates less at other wavelengths.

As described, the surfaces of the magnetic head and the magnetic storage medium are coated with the coating layer materials having the same elementary composition. Accordingly, the electric charge transfer that occurs as the magnetic head comes into contact with the storage medium is suppressed, thereby preventing the degradation in the floating characteristics due to the electric charge transfer and degradation of the magnetic head due to the discharge.

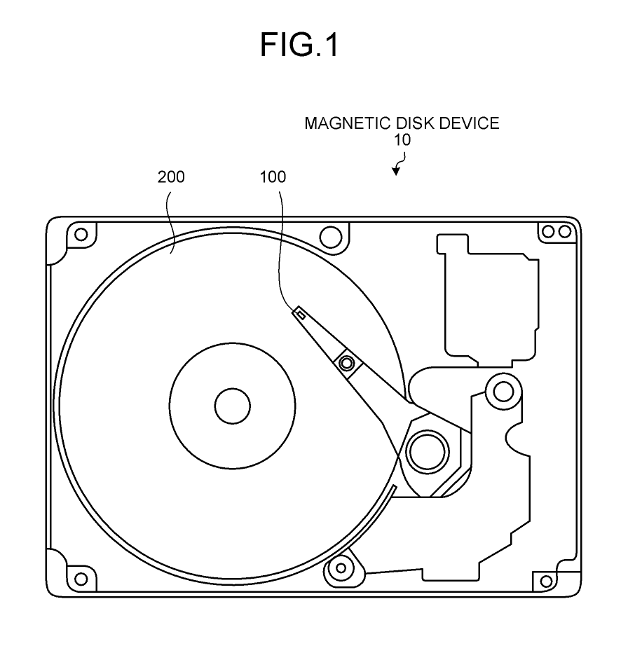

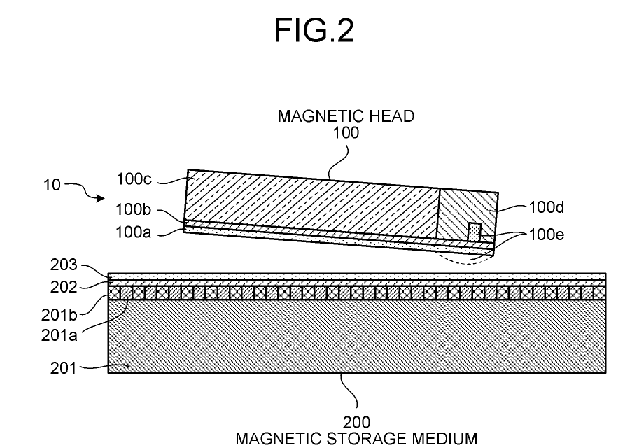

The magnetic disk device including the magnetic head and the magnetic storage medium is explained with reference to FIGS. 1 and 2. FIG. 1 is a schematic diagram of an example of a magnetic disk device 10 according to the first embodiment of the present invention. As depicted in FIG. 1, the magnetic disk device 10 includes a magnetic head 100 and a magnetic storage medium 200 that are closely related to the present invention.

The relationship between the magnetic head 100 and the magnetic storage medium 200 is explained. FIG. 2 is a cross-sectional view indicating the relationship between the magnetic head 100 and the magnetic storage medium 200 (a cross-sectional view obtained by cutting the magnetic disk device 10 in a vertical direction).

As depicted in FIG. 2, the magnetic head 100 floats over the surface of the magnetic storage medium 200 by a very small distance that is greater than 0 nm and less than 3 nm from the surface to move over and read/write magnetic data from/to the magnetic storage medium 200. The magnetic head 100 includes a coating film 100a, a head DLC 100b, a head substrate 100c, a DFH control unit 100d, and a head element 100e.

The coating film 100a is a material of a coating layer coating the surface of the magnetic head 100 and reduces friction against the magnetic storage medium 200. Examples of the material of the coating layer include a fluorine compound such as a perfluoropolyether.

The head DLC 100b functions as a protective film for the magnetic head 100. A material of the head DLC 100b may be tetrahedral amorphous carbon (hereinafter, “ta:C”), which is capable of being formed into a thin film and includes a large number of sp3 carbons. The sp3 carbons are carbons composed of single-bonds, not conductive, and have strong resistance to friction or the like. Therefore, the sp3 carbons are suitable as a material of the protective film of the magnetic head.

The head substrate 100c, which is a main part of the magnetic head 100, has a bar-like shape cut out in strips from a wafer. The head substrate 100c floats and moves over the surface of the magnetic storage medium 200.

The DFH control unit 100d corrects variation in flying height of the magnetic head 100 before the magnetic disk device 10 is shipped. Specifically, the head element 100e is thermally expanded as depicted by a dotted line in FIG. 2 by turning on the heater (not depicted) included in the DFH control unit 100d to bring the head element 100e into contact with the magnetic storage medium 200.

A read waveform is distorted as the head element 100e contacts the magnetic storage medium 200 and causes vibration. When the contact is detected, the heater is turned off. Consequently, the thermally-expanded area depicted by the dotted line in FIG. 2 becomes a magnetic spacing and thus the variation in the flying height of the magnetic head 100 is suppressed.

The magnetic storage medium 200 realizes high density recording with regularly arranged magnetic bodies for recording information. The magnetic storage medium 200 includes a substrate 201, a medium DLC 202, and a coating film 203.

On the substrate 201, which is a disk on which the magnetic bodies are applied, information is recorded and held. A magnetic film that corresponds to a surface layer of the substrate 201 is shaped such that magnetic interference between tracks or bits is suppressed. Insulating bodies 201a and magnetic bodies 201b are arranged on the substrate 201. Examples of the insulating bodies 201a include silicon dioxide (SiO₂) and alumina.

The medium DLC 202 functions as a protective film of the magnetic storage medium 200. Representative examples of a material of the medium DLC 202 include the ta:C, which is capable of being formed into a thin film and rich in sp3 carbons.

The coating film 203 is deposited on the medium DLC 202 and reduces friction against the magnetic head 100. The elementary composition of the material of the coating film 203 is the same as that of the coating film 100a coating the surface of the magnetic head 100.

Thus, the elementary compositions of the materials of the coating film 100a coating the surface of the magnetic head 100 and the coating film 203 coating the surface of the magnetic storage medium 200 are the same.

The example of coating the surfaces of the magnetic head and the magnetic storage medium with the materials of the coating layers having the same elementary composition has been explained. Furthermore, the surfaces may be coated with the materials of the coating layers having the same elementary composition ratio so that the electric charge transfer between the magnetic head and the magnetic storage medium is reduced even more and the degradation in the floating characteristics due to the electric charge transfer and the degradation of the magnetic head due to the discharge are even more effectively prevented.

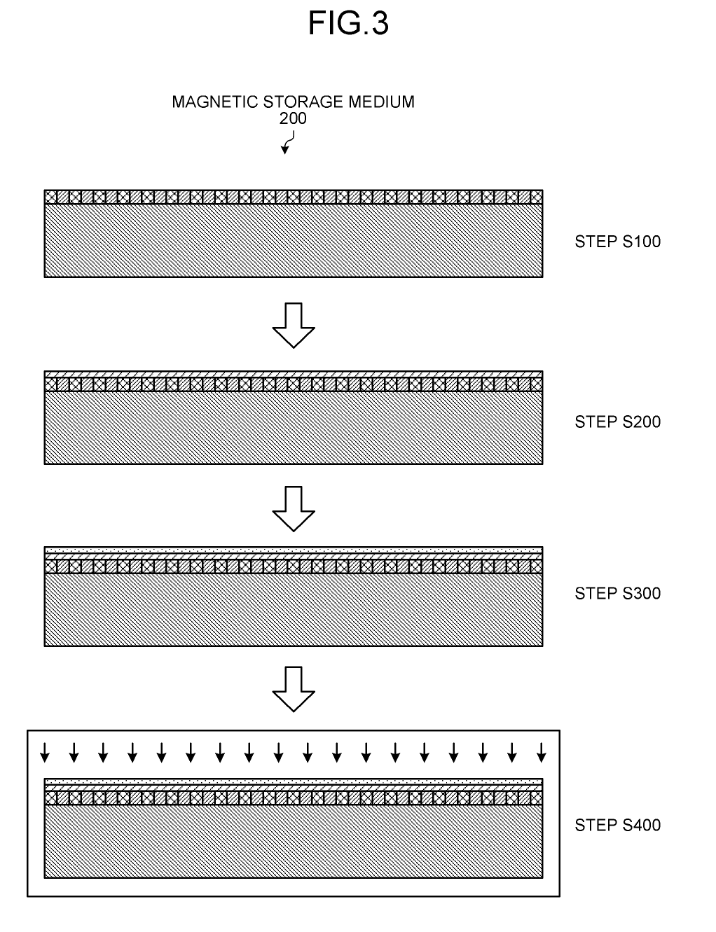

A film forming process of the magnetic head 100 and the magnetic storage medium 200 depicted in FIGS. 1 and 2 is explained. FIG. 3 is a schematic diagram for explaining the film forming process according to the first embodiment.

As depicted in FIG. 3, a substrate of a discrete track medium (DTM) for perpendicular-recording is made (Step S100). In the substrate, the magnetic film is divided by SiO₂.

Next, a ta:C is deposited on the DTM substrate made at Step S100 as the protective film by a filtered cathodic arc method (Step S200).

Next, a perfluoropolyether having —CF₃ at a molecular end group and —CF₂CF₂O— as a repeat unit in a main chain is coated on the protective film deposited at Step S200 with a thickness of 0.9 nm (Step S300). With this thickness, the molecules of perfluoropolyether forming the coating layer cover over the protective film without overlapping each other in the flying height direction.

Next, Xe excimer light having emission lines of a wavelength of 172 nm is irradiated in nitrogen atmosphere on the entire surface of the magnetic storage medium 200, so that the perfluoropolyether coated at Step S300 is fixed onto the ta:C (Step S400).

As for the magnetic head 100, the head substrate 100c is cut out in strips from a wafer, and the cut section of the head substrate 100c is polished. Then, a ta:C is deposited on the cut section as the protective film by the filtered cathodic arc method described at Step S200.

The same perfluoropolyether as that coated on the surface of the magnetic storage medium 200 is coated on the surface of the magnetic head 100 with a thickness of 0.7 nm, and fixed onto the ta:C by the same step as Step S400.

The perfluoropolyether is coated on the magnetic head 100 with a thickness of 0.7 nm, so that the total of film thicknesses including the material of the coating layer coated on the magnetic storage medium 200 is 1.6 nm.

Accordingly, the perfluoropolyether is coated on the surfaces of the magnetic head 100 and the magnetic storage medium 200 with the total film thickness (2.0 nm or less) at which the degradation of the floating characteristics of the magnetic head 100 is prevented.

The magnetic disk device 10 was made using the magnetic head 100 and the magnetic storage medium 200 that were made by the above film forming method. The head element 100e was projected by the DFH control unit 100d of the magnetic disk device 10, moved down to touch the magnetic storage medium 200, and moved back up by 2 nm. The magnetic head 100 was floated at this height (the minimum distance of the magnetic spacing for a read/write process was 2 nm), and the read/write process was repeated for 48 hours.

Another magnetic disk device (not depicted) was made using a discrete track medium (a magnetic storage medium 60) for perpendicular-recording and a magnetic head 50 having only a ta:C on the surface thereof and including a DFH mechanism. The magnetic storage medium 60 was made by applying a commercially-available lubricant including a hydroxy end group with high polarity on a typical chemical vapor deposition (CVD) carbon.

Similarly to the operations performed with the magnetic disk device 10, the head element was projected by the DFH, moved down to touch the storage medium, and moved back up by 2 nm. The magnetic head 50 was floated at this height (the minimum distance of the magnetic spacing for a read/write process was 2 nm), and the read/write process was repeated for 48 hours.

Consequently, no errors occurred in the operation of the magnetic disk device 10. Many errors occurred in the operation of the magnetic disk device including the magnetic head 50 and the magnetic storage medium 60. When each magnetic disk device was disassembled and the surface of the magnetic storage medium and a floating surface of the magnetic head were observed, traces of contact were found on the magnetic head 50 and the magnetic storage medium 60.

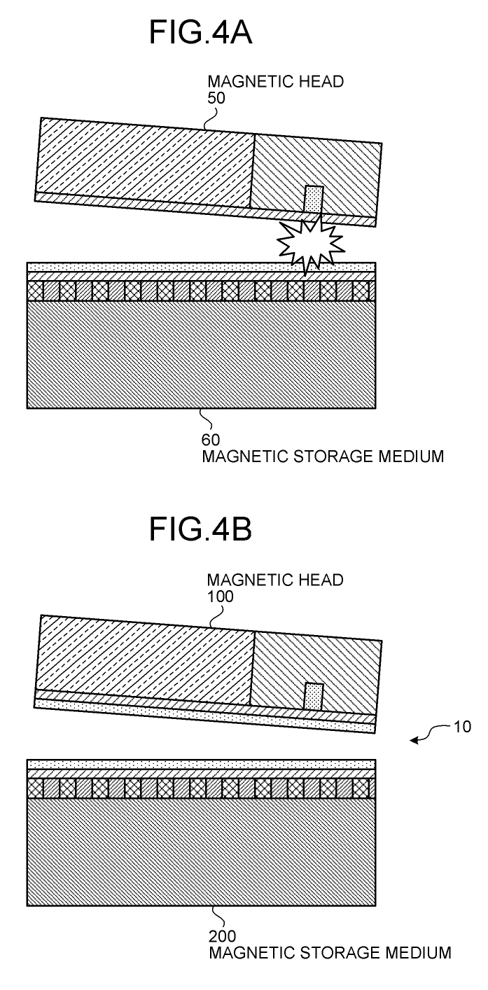

FIG. 4 is a schematic diagram for explaining an advantage of the magnetic disk device according to the first embodiment. As depicted in FIG. 4, in the conventional magnetic disk device including the magnetic head 50 and the magnetic storage medium 60, electric charge transfer (electron transfer due to a difference in electro-negativities) occurs due to the contact between the magnetic head 50 and the magnetic storage medium 60.

Moreover, in the conventional magnetic disk device, because the lubricant is adsorbed with the low bonding rate, electric charge accumulation or transfer occurs easily due to transfer of the lubricant onto the magnetic head caused by evaporation of the lubricant, or drop of the lubricant. Therefore, the floating characteristics of the magnetic head degrade, which results in read/write errors by the magnetic head and damages in the magnetic storage medium and the magnetic head.

The surfaces of the magnetic head 100 and the magnetic storage medium 200 are coated with the materials of the coating layers having the same elementary composition, thus suppressing the electric charge transfer due to the contact between the magnetic head 100 and the magnetic storage medium 200.

Moreover, because the perfluoropolyether is adsorbed on the DLC at the high bonding rate, the electric charge accumulation or transfer due to the transfer of the perfluoropolyether onto the magnetic head or the drop of perfluoropolyether is suppressed. Therefore, it is possible to prevent the floating characteristics of the magnetic head from degrading, and to prevent read/write errors by the magnetic head and damages in the magnetic head and the magnetic storage medium.

According to the magnetic disk device of the first embodiment, the surfaces of the magnetic head 100 and the magnetic storage medium 200 are coated with the materials of the coating layers having the same elementary composition, so that the electric charge transfer generated upon contact between the magnetic head 100 and the magnetic storage medium 200 is suppressed, and degradation in the floating characteristics of the magnetic head 100 and degradation of the magnetic head 100 due to discharge are prevented.

In the present embodiment, the magnetic storage medium has been explained with respect to a discrete track medium for perpendicular-recording. However, the present invention is not limited to this example. Any other storage medium or disk device, such as a patterned medium or a bit-patterned medium used in a hard disk device, may be used. Moreover, the magnetic disk device according to the present embodiment includes any magnetic disk device that uses such a magnetic storage medium.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A magnetic disk device comprising:
a magnetic storage medium including a surface coated with a first coating layer material having an elementary composition; and
a magnetic head including a surface coated with a second coating layer material having the elementary composition.

2. The magnetic disk device according to claim 1, wherein the first and second coating layer materials have a same elementary composition ratio.

3. The magnetic disk device according to claim 1, further comprising an adjusting unit that adjusts a flying height of the magnetic head from the magnetic storage medium to a predetermined value by thermally expanding a thermal expansion element included in the magnetic head.

4. The magnetic disk device according to claim 3, wherein the predetermined value is greater than 0 nanometer and equal to or less than 3 nanometers.

5. The magnetic disk device according to claim 1, wherein
a total of film thicknesses of the first and second coating layer materials coating the surfaces of the the magnetic storage medium and the magnetic head is equal to or less than 2 nanometers, and
the film thickness of the second coating layer material coating the surface of the magnetic head is equal to or less than that of the first coating layer material coating the surface of the magnetic storage medium.

6. The magnetic disk device according to claim 1, wherein the first and second coating layer materials are a fluorine compound.

7. The magnetic disk device according to claim 6, wherein the fluorine compound includes a perfluoropolyether.

8. The magnetic disk device according to claim 7, wherein the perfluoropolyether does not include a polar end group but includes at least one of a —CF₃ end group and a —CH₃ end group, and does not include a monomer unit including —CF₂O—.

9. The magnetic disk device according to claim 1, wherein at least one of the first and second coating layer materials is/are adsorbed on the surface/surfaces on which the at least one of the first and second coating layer materials is/are coated, under irradiation with a radiation including a plurality of emission lines with at least one of wavelengths of 185 nanometers and 172 nanometers in an inert gas atmosphere or under vacuum.

10. The magnetic disk device according to claim 1, wherein the magnetic storage medium is a discrete track medium or a bit patterned medium.

11. The magnetic disk device according to claim 1, wherein the magnetic storage medium comprises magnetic patterns and an insulating body filled in between the magnetic patterns.
